(19) United States
(12) Patent Application Publication
(10) Pub. No.: US 2025/0268347 A1
(43) Pub. Date: Aug. 28, 2025

(54) ADJUSTABLE UMBRELLA FOR PROVIDING A PROTECTED AREA TO A USER

(71) Applicant: MUJTABA AZIZ MOHAMMED, HYDERABAD (IN)

(72) Inventor: MUJTABA AZIZ MOHAMMED, HYDERABAD (IN)

(21) Appl. No.: 18/588,539

(22) Filed: Feb. 27, 2024

(51) Int. Cl. A45B 25/20; A45B 23/00; G09F 23/00

(52) U.S. Cl. CPC A45B 25/20; A45B 23/00; G09F 23/00; A45B 2023/0012; A45B 2200/1009

(57) ABSTRACT

Disclosed in the present invention is an adjustable umbrella with a solar protection layer, a transparent layer, which provides an adjustable protected area to a user, comprising, a canopy attached to a plurality of ribs, the plurality of ribs configured to support and extend the canopy to provide a protected area for a user, a vertical pole attached to the canopy via a plurality of screws and the plurality of ribs, the vertical pole configured to enable a user to open and close the canopy, a first layer from an inside of the canopy configured to protect the user from ultraviolet rays and a second layer on a top center of the canopy configured to provide a clear view of sky to the user, and an extended bat above the canopy configured to make easy for mounting at least one board, the board comprising a direction sign board.

### TECHNICAL FIELD

The present invention relates generally to an umbrella, and more particularly, the present disclosure relates to an adjustable umbrella with a solar protection layer, a transparent layer, and a method employed thereof, wherein the adjustable umbrella provides an adjustable protected area to a user.

### BACKGROUND ART

Umbrellas are frequently used in everyday living for not only sheltering rain, but also providing functions of sunlight shading, and wind shielding. On a windy rainy day, one common concern that people may have while using umbrellas is that strong winds or gusts may blow the umbrella inside out. This gives the user a sense of insecurity. Traditional umbrellas are designed to deploy a canopy that protects an area of fixed size from rain and sunlight. But the traditional umbrellas fail to give full protection to a user.

There are certain jobs that people find needless and some look very easy but when one goes into the detail that the people truly find out the tremendous effort, and hard work required for the job, and how that profile is saving lives, finances and making the job easier for all the departments. Some profiles have to remain on-site even if the work stops. These remain stationed and alert avoiding accidents, displaying warnings, and alerting the civilians of any hazards around. These people are indeed strong but deserve indispensable protection and care. It is not fair to overlook the consequences and not think of proposing any easy solution while ignoring the serious health hazards that are posed due to long exposure to ultraviolet rays like skin cancer, damaged DNA in the skin cells, besides eczema and other yeast infections caused due to long hours in wet clothes and footwear albeit being equipped enough in rainproof gears. Thus, there is a need for an adjustable umbrella that protects a user from exposure to ultraviolet rays, getting wet in the rain, as well as other weather conditions such as snow, and overhead hazards.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An exemplary embodiment of the present disclosure directed towards an adjustable umbrella with a solar protection layer, a transparent layer, and a method employed thereof.

An objective of the present disclosure is directed towards an adjustable umbrella can be used in multiple industries like traffic controllers, flaggers in construction, traffic police, maritime, surveyors, gatekeepers, and the like.

Another objective of the present disclosure is directed towards an adjustable umbrella that provides an ultraviolet protection layer or solar protection layer from the inside.

Another objective of the present disclosure is directed towards an adjustable umbrella that provides a transparent layer on the top center for a clear view of the mounted sign directions and for any overhead hazards as well.

Another objective of the present disclosure is directed towards an adjustable umbrella that can be customized in accordance with regulatory standards and also industry requirements.

Another objective of the present disclosure is directed towards an adjustable umbrella that makes easy for mounting alert sign boards.

Another objective of the present disclosure is directed towards adjustable umbrella that withstands different climatic conditions and at the same time makes easy to hold and easy to store.

According to an exemplary embodiment of the present disclosure, an adjustable umbrella comprising a canopy configured to attach to a plurality of ribs, whereby the plurality of ribs configured to support and extend the canopy to provide a protected area for a user.

According to another exemplary embodiment of the present disclosure, the adjustable umbrella comprising a vertical pole attached to the canopy via a plurality of screws and the plurality of ribs, the vertical pole configured to enable a user to open and close the canopy.

According to another exemplary embodiment of the present disclosure, the adjustable umbrella comprising a first layer from an inside of the canopy configured to protect the user from ultraviolet rays and a second layer on a top center of the canopy configured to provide a clear view of sky to the user.

According to another exemplary embodiment of the present disclosure, the adjustable umbrella comprising an extended bat above the canopy configured to make easy for mounting at least one board, whereby the at least one board comprising at least one of: a direction sign board; an advertisement board; a billboard; and a traffic sign board.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is an embodiment of an adjustable umbrella, in accordance with one or more exemplary embodiments of the present disclosure.

FIG. 2 is another embodiment of an adjustable umbrella, in accordance with one or more exemplary embodiments of the present disclosure.

FIG. 3 is an embodiment of a canopy, in accordance with one or more exemplary embodiments of the present disclosure.

FIG. 4A is an embodiment of an extended bat above the canopy, in accordance with one or more exemplary embodiments of the present disclosure.

FIG. 4B is an embodiment of a customized canopy, in accordance with one or more exemplary embodiments of the present disclosure.

FIG. 4C is an embodiment of a vertical pole, in accordance with one or more exemplary embodiments of the present disclosure.

FIG. 5A is an embodiment of a canopy's first layer, in accordance with one or more exemplary embodiments of the present disclosure.

FIG. 5B is an embodiment of an extended bat, in accordance with one or more exemplary embodiments of the present disclosure.

FIG. 5C is an embodiment of a canopy's second layer, in accordance with one or more exemplary embodiments of the present disclosure.

### DETAILED DESCRIPTION OF EXAMPLE OF EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one clement from another.

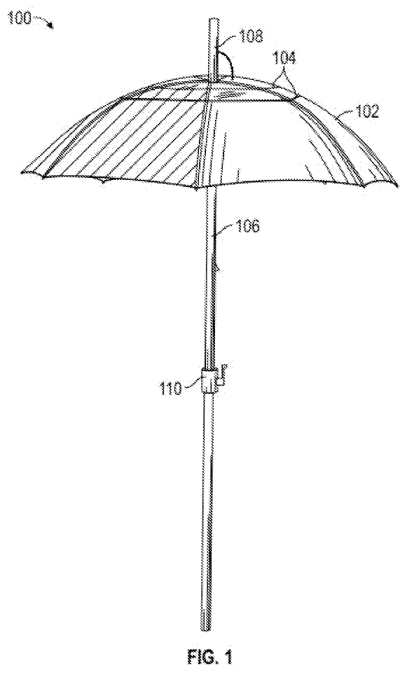

Referring to FIG. 1 is an embodiment 100 of an adjustable umbrella for providing protected area to a user, in accordance with one or more exemplary embodiments of the present disclosure. The adjustable umbrella 100 includes a canopy 102, ribs 104, a vertical pole 106, an extended bat 108, and an adjuster 110. The canopy 102 may be attached to the ribs 104. The ribs 104 may be configured to support and extend the canopy 102 to provide a protected area for a user. The vertical pole 106 may be attached to the canopy via screws and the ribs 104 and the vertical pole 106 may be configured to enable the user to open and close the canopy 102.

In accordance with one or more exemplary embodiments of the present disclosure, a first layer from an inside of the canopy 102 may be configured to protect the user from ultraviolet rays and a second layer on a top center of the canopy 102 may be configured to provide a clear view of sky to the user. The extended bat 108 may be located above the canopy 102 configured to make easy for mounting a board. The extended bat 108 may include, but not limited to, slow stop bat, lollipop bat, flagger bats, slow stop sign bats, and the like. The first layer and the second layer may be separated by a windproof pole. The canopy 102 may be customized by color materials in accordance with regulatory standards and industry requirements. The first layer may include an ultraviolet protection layer and the second layer may include a transparent layer. The vertical pole 106 includes an adjuster 110 configured to adjust the canopy 102 to user's height or preferential length of coverage.

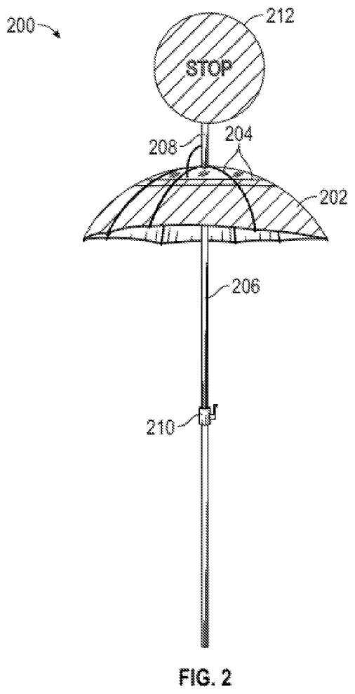

Referring to FIG. 2 is another embodiment 200 of an adjustable umbrella for providing protected area to a user, in accordance with one or more exemplary embodiments of the present disclosure. The adjustable umbrella 200 includes the canopy 202, ribs 204, the vertical pole 206, the extended bat 208, the adjuster 210, and a board 212. The canopy 202 may be attached to the ribs 204. The ribs 204 may be configured to support and extend the canopy 202 to provide a protected area for a user. The vertical pole 206 may be attached to the canopy 202 via screws and the ribs 204 and the vertical pole 206 may be configured to enable the user to open and close the canopy 202. The extended bat 208 above the canopy 202 may be configured to make easy for mounting the board 212. The board 212 may include, but not limited to, a direction sign board, an advertisement board, a billboard, a traffic sign board, and the like. The adjuster 210 may be configured to adjust the canopy 202 to user's height or preferential length of coverage.

The adjustable umbrella 200 may be designed in various types, and used in multiple industries like traffic controller, flaggers in construction, traffic police, maritime, surveyors, gatekeepers, and the like. The board 212 may be configured to display warnings and alert the civilians of hazards around the location.

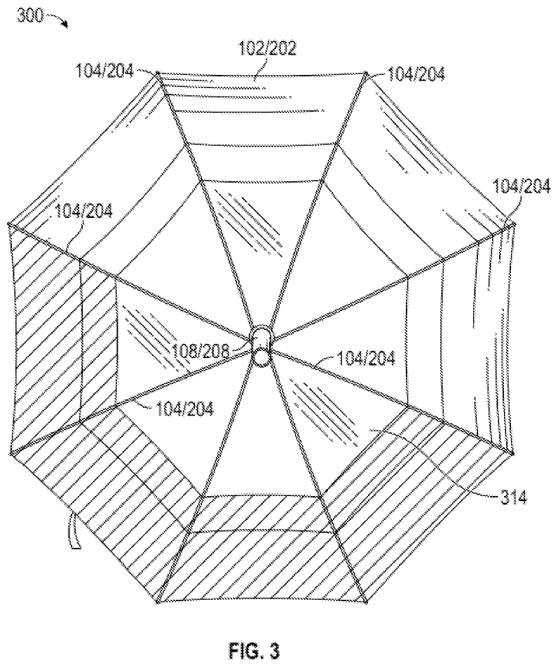

Referring to FIG. 3 is an embodiment 300 of the canopy, in accordance with one or more exemplary embodiments of the present disclosure. The canopy 102 or 202 may be used in industries like traffic controllers, flaggers in construction, traffic police, maritime, surveyors, gatekeepers, and the like. The canopy 102 or 202 may include the transparent layer 314 configured to provide the clear view of the mounted board 212 and overhead hazards. The canopy 102 or 202 may be customized by color materials in accordance with regulatory standards and industry requirements. The extended bat 108 or 208 above the canopy 102 or 202 may be configured to secure the board 212.

In accordance with one or more exemplary embodiments of the present disclosure, the canopy 102 or 202 includes 23′×8 k×30 mm, an upper layer 12 cc transparent layer, down layer 190 T silver ultraviolet, 30 mm white aluminum shaft with white coated tube, 2.8/3.0 mm white coated frame, and white plastic tips without handle open diameter.

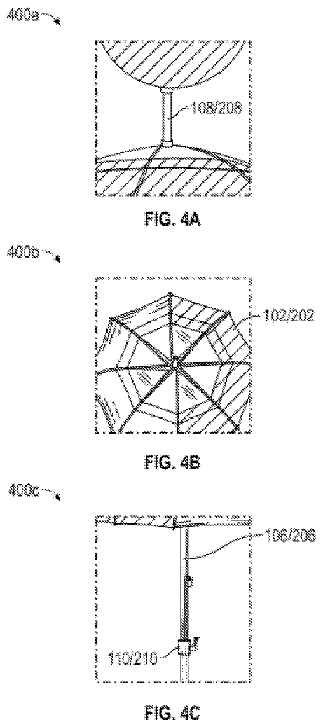

Referring to FIG. 4A is an embodiment 400A of an extended bat above the canopy, in accordance with one or more exemplary embodiments of the present disclosure. The extended bat 108 or 208 above the canopy 102 or 202 may be configured to make easy for mounting the board 212. The board 212 may include, but not limited to, a stop board, a direction sign board, an advertisement board, a billboard, a traffic sign board, and the like.

Referring to FIG. 4B is an embodiment 400B of the canopy, in accordance with one or more exemplary embodiments of the present disclosure. The canopy 400B is customized by color materials in accordance with regulatory standards and industry requirements. The color materials may include, but not limited to, yellow material, red material, blue material, white material, and the like.

Referring to FIG. 4C is an embodiment 400C of a vertical pole, in accordance with one or more exemplary embodiments of the present disclosure. The vertical pole 106 or 206 includes the adjuster 110 or 210 configured to adjust the canopy 102 or 202 to user's height or preferential length of coverage. The adjuster 110 or 210 may be configured to adjust the canopy 102 or 202 to user's height or preferential length of coverage. The vertical pole 106 or 206 may include a flat base for easy handling to the user.

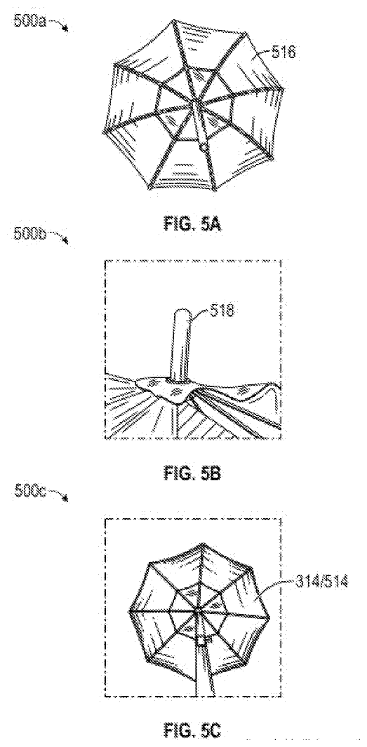

Referring to FIG. 5A is an embodiment 500A of a canopy's ultra violet protection layer, in accordance with one or more exemplary embodiments of the present disclosure. The ultra violet protection layer 516 from an inside of the canopy 102 or 202 may be configured to protect the user from ultraviolet rays.

Referring to FIG. 5B is an embodiment 500B of an extended bat, in accordance with one or more exemplary embodiments of the present disclosure. The first layer 516 and the second layer 314 may be separated by a windproof pole 518.

Referring to FIG. 5C is an embodiment 500C of a canopy's second layer, in accordance with one or more exemplary embodiments of the present disclosure. The second layer 314 may include the transparent layer on the top center of the canopy 102 or 202 for the clear view of the mounted board and for any overhead hazards. The second layer 314 on a top center of the canopy 102 or 202 may be also configured to provide the clear view of sky to the user.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

### INDUSTRIAL APPLICATION

The present invention applies to umbrellas. It provides an adjustable umbrella with a solar protection layer, a transparent layer. It also avails a method adjusting the umbrella, wherein the adjustable umbrella provides an adjustable protected area to a user.

We claim:

1. An adjustable umbrella, comprising:
a canopy attached to a plurality of ribs, whereby the plurality of ribs configured to support and extend the canopy to provide a protected area for a user;
a vertical pole attached to the canopy via a plurality of screws and the plurality of ribs, the vertical pole configured to enable a user to open and close the canopy;
a first layer from an inside of the canopy configured to protect the user from ultraviolet rays and a second layer on a top center of the canopy configured to provide a clear view of sky to the user; and
an extended bat above the canopy configured to make easy for mounting at least one board, whereby the at least one board comprising at least one of: a direction sign board; an advertisement board; a billboard; and a traffic sign board.

2. The adjustable umbrella of claim 1, wherein the first layer and the second layer are separated by a windproof pole.

3. The adjustable umbrella of claim 1, wherein the first layer comprising an ultraviolet protection layer and the second layer comprising a transparent layer.

4. The adjustable umbrella of claim 1, wherein the second layer is configured to provide the clear view of the mounted board and overhead hazards.

5. The adjustable umbrella of claim 1, wherein the canopy is customized by a plurality of color materials in accordance with regulatory standards and industry requirements.

6. The adjustable umbrella of claim 1, wherein the vertical pole comprising an adjuster configured to adjust the canopy to user's height or preferential length of coverage.

7. The adjustable umbrella of claim 1, wherein the vertical pole comprising a flat base configured for easy handling to the user.
